(19) United States
(12) Patent Application Publication
(10) Pub. No.: US 2022/0024384 A1
(43) Pub. Date: Jan. 27, 2022

(54) VEHICLE MONITORING DEVICE, VEHICLE MONITORING METHOD AND NON-TRANSITORY MEMORY MEDIUM

(71) Applicant: TOYOTA JIDOSHA KABUSHIKI KAISHA, Toyota-shi (JP)

(72) Inventor: Yamato YORIFUJI, Aichi-ken (JP)

(73) Assignee: TOYOTA JIDOSHA KABUSHIKI KAISHA, Toyota-shi (JP)

(21) Appl. No.: 17/333,765

(22) Filed: May 28, 2021

(51) Int. Cl. B60R 1/00; B62D 33/027; G06K 9/00; H04N 5/91

(52) U.S. Cl. CPC B60R 1/00; B62D 33/027; B60R 2300/10; H04N 5/91; B60R 2300/20; G06K 9/00791

(57) ABSTRACT

A vehicle monitoring device for installment in a vehicle in which a cargo bed is provided at a rear side of a cabin and a tailgate is provided at a rear end portion of the cargo bed. The vehicle monitoring device includes a memory and a processor connected to the memory. The processor is configured to cause a first imaging unit installed at a rear face portion of the tailgate to capture an image rearward of the vehicle, cause a second imaging unit installed at a cabin rear end portion side of an upper portion of the vehicle to capture an image of the cargo bed and rearward of the vehicle, cause an open or closed state acquisition section to acquire an open or closed state of the tailgate, and when a state in which the tailgate is in a closed state is acquired by the open or closed state acquisition section, use images captured by the first imaging unit to assist monitoring rearward of the vehicle, and when a state in which the tailgate is in an open state is acquired by the open or closed state acquisition section, use images captured by the second imaging unit to assist monitoring rearward of the vehicle.

### CROSS-REFERENCE TO RELATED APPLICATION

This application is based on and claims priority under 35 USC 119 from Japanese Patent Application No. 2020-124456 filed on Jul. 21, 2020, the disclosure of which is incorporated by reference herein.

### BACKGROUND

### Technical Field

The present disclosure relates to a monitoring device for a vehicle, a monitoring method for a vehicle, and a non-transitory memory medium.

### Related Art

A technology relating to a driving recorder mounted in a vehicle is disclosed in, for example, Japanese Patent Application Laid-Open (JP-A) No. 2008-134844. To describe this technology briefly, a camera is installed on a vehicle and the driving recorder records images captured by the camera.

A vehicle is known in which a cargo bed is provided at a rear side of a cabin and a tailgate is provided at a rear end portion of the cargo bed. In this vehicle, the tailgate may be put into an open state and a load placed on the cargo bed, and the vehicle may run in this state. In this state, in a structure in which a camera is installed at a rear face portion of the tailgate (a face portion that is oriented to the vehicle rear side in a closed state of the tailgate), the camera may image a road surface and not be able to image rearward of the vehicle. Thus, there is scope for improvement in assisting monitoring rearward of the vehicle.

### SUMMARY

An object of the present disclosure is to provide a vehicle monitoring device that may acquire images rearward of the vehicle and excellently assist monitoring rearward of the vehicle even when the vehicle is running with a tailgate in an open state.

A vehicle monitoring device according to a first aspect is for installment in a vehicle in which a cargo bed is provided at a rear side of a cabin and a tailgate is provided at a rear end portion of the cargo bed, the vehicle monitoring device including a memory and a processor connected to the memory. The processor is configured to: cause a first imaging unit installed at a rear face portion of the tailgate to capture an image rearward of the vehicle; cause a second imaging unit installed at a cabin rear end portion side of an upper portion of the vehicle to capture an image of the cargo bed and rearward of the vehicle; cause an open or closed state acquisition section to acquire an open or closed state of the tailgate; and when a state in which the tailgate is in a closed state is acquired by the open or closed state acquisition section, use images captured by the first imaging unit to assist monitoring rearward of the vehicle, and when a state in which the tailgate is in the open state is acquired by the open or closed state acquisition section, use images captured by the second imaging unit to assist monitoring rearward of the vehicle. The meaning of the term “rear face portion of the tailgate” as used herein is intended to include a face portion of the tailgate that is oriented to the vehicle rear side in a closed state of the tailgate.

According to the structure described above, the first imaging unit is installed at the rear face portion of the tailgate, and the first imaging unit images rearward of the vehicle. The second imaging unit is installed at the upper portion of the vehicle, at the cabin rear end portion side, and the second imaging unit images the cargo bed and rearward of the vehicle. Open or closed state of the tailgate is acquired by the open or closed state acquisition section. When the tailgate being in the open state is acquired by the open or closed state acquisition section, the processor uses images captured by the first imaging unit to assist monitoring rearward of the vehicle. When the tailgate being in the closed state is acquired by the open or closed state acquisition section, the processor uses images captured by the second imaging unit to assist monitoring rearward of the vehicle. Therefore, in both the open and closed states of the tailgate, images rearward of the vehicle may be used to assist monitoring excellently.

In a vehicle monitoring device according to a second aspect, in the first aspect, the vehicle monitoring device further includes a display section that is provided in the cabin of the vehicle and displays images, and the processor is configured to, when a state in which the tailgate is in the closed state is acquired by the open or closed state acquisition section, display images captured by the first imaging unit at the display section, and when a state in which the tailgate is in the open state is acquired by the open or closed state acquisition section, display images captured by the second imaging unit at the display section.

According to the structure described above, the vehicle monitoring device includes the display section provided in the cabin of the vehicle. When the tailgate being in the closed state is acquired by the open or closed state acquisition section, the processor causes images captured by the first imaging unit to be displayed at the display section. When the tailgate being in the open state is acquired by the open or closed state acquisition section, the processor causes images captured by the second imaging unit to be displayed at the display section. Therefore, in both the open and closed states of the tailgate, images rearward of the vehicle may be displayed at the display section in the cabin.

In a vehicle monitoring device according to a third aspect, in the first aspect or the second aspect, the vehicle monitoring device further includes a recording section that records images, and the processor is configured to, when a state in which the tailgate is in the closed state is acquired by the open or closed state acquisition section, record images captured by the first imaging unit at the recording section, and when a state in which the tailgate is in the open state is acquired by the open or closed state acquisition section, record images captured by the second imaging unit at the recording section.

According to the structure described above, the vehicle monitoring device includes the recording section. When the tailgate being in the closed state is acquired by the open or closed state acquisition section, the processor causes images captured by the first imaging unit to be recorded at the recording section. When the tailgate being in the open state is acquired by the open or closed state acquisition section, the processor causes images captured by the second imaging unit to be recorded at the recording section. Therefore, in both the open and closed states of the tailgate, images rearward of the vehicle may be recorded.

As described above, according to the vehicle monitoring device of the present disclosure, an excellent effect is provided in that images rearward of a vehicle may be acquired and may assist monitoring rearward of the vehicle excellently even when the vehicle is running with a tailgate in an open state.

### BRIEF DESCRIPTION OF THE DRAWINGS

Exemplary embodiments of the present invention will be described in detail based on the following figures, wherein:

FIG. 1 is a vehicle side view diagram schematically showing general structure of a vehicle equipped with a vehicle monitoring device according to an exemplary embodiment, in a state in which a tailgate is closed;

FIG. 2 is a vehicle side view diagram schematically showing the vehicle of FIG. 1 in a state in which the tailgate is open;

FIG. 3 is a block diagram showing an example of hardware structures of the vehicle monitoring device;

FIG. 4 is a block diagram showing an example of functional structures of a camera ECU of the vehicle monitoring device;

FIG. 5 is a flowchart showing an example of flow of image display control processing by the camera ECU of the vehicle monitoring device; and

FIG. 6 is a flowchart showing an example of flow of image recording control processing by the camera ECU of the vehicle monitoring device.

### DETAILED DESCRIPTION

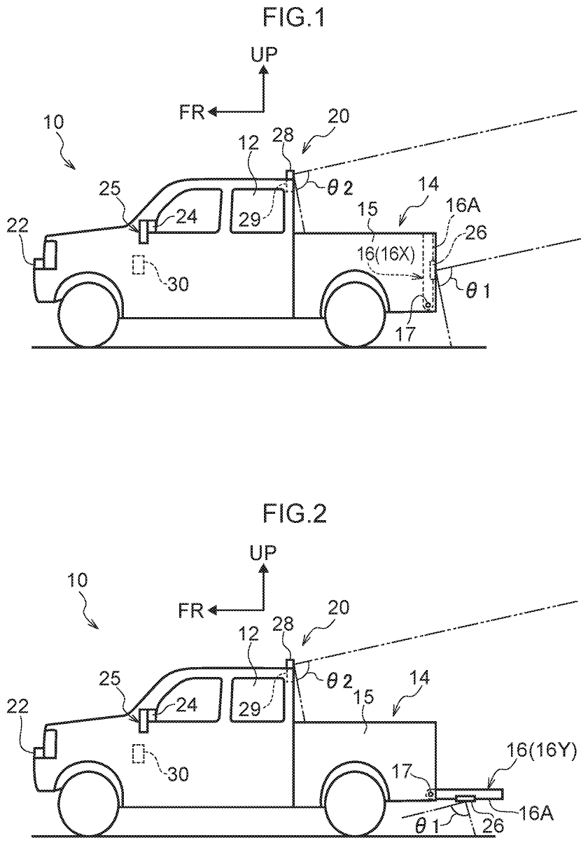

A vehicle monitoring device according to an exemplary embodiment of the present disclosure is described using FIG. 1 to FIG. 6. An arrow FR that is shown in FIG. 1 and FIG. 2 indicates a vehicle front side, and an arrow UP indicates a vehicle upper side.

FIG. 1 schematically shows a vehicle side view of general structure of a vehicle 10 in which a vehicle monitoring device 20 according to the exemplary embodiment is installed. The vehicle 10 is provided with a cargo bed 14 at the rear side of a cabin 12. Side panels 15 are provided at both vehicle width direction sides of the cargo bed 14, and a tailgate 16 is provided at a rear end portion of the cargo bed 14. A turning pivot 17 is provided along the vehicle width direction at a lower end portion of the tailgate 16, enabling turning of the tailgate 16 about the turning pivot 17. That is, the tailgate 16 is turnable between a closed position 16X, at which the tailgate 16 closes a gap between rear end portions of the left and right pair of side panels 15, and an open position 16Y (see FIG. 2), at which the tailgate 16 projects to the vehicle rear side and opens up the gap between the rear end portions of the left and right pair of side panels 15.

A front camera (also referred to as a forward camera) 22 is provided at a front face portion of the vehicle 10. The front camera 22 is installed at a grille (not shown in the drawings) and images forward of the vehicle 10. Side cameras (also referred to as sideward cameras) 24 are provided at side portions of the vehicle 10. The side cameras 24 are installed at outer mirror apparatuses 25 and image sideward and side-rearward of the vehicle 10.

A rear camera (also referred to as a rearward camera) 26 is provided at a rear face portion of the vehicle 10. The rear camera 26 serves as a first imaging unit. The rear camera 26 is installed at a rear face portion 16A of the tailgate 16 and images rearward of the vehicle 10. In the drawings, an example of a field of view of the rear camera 26 is indicated with the symbol θ1. A bed camera (also referred to as an upper portion camera) 28 is provided at an upper portion of the vehicle 10. The bed camera 28 serves as a second imaging unit. The bed camera 28 is installed at a cabin rear end portion side of the upper portion of the vehicle 10. The bed camera 28 is disposed at the upper side relative to a center high mount stop lamp apparatus 29. The bed camera 28 images the cargo bed 14 and rearward of the vehicle 10. In the drawings, an example of a field of view of the bed camera 28 is indicated with the symbol θ2.

The front camera 22, side cameras 24, rear camera 26 and bed camera 28 may be understood as being vicinity monitoring cameras for acquiring images (video images) of the surroundings of the vehicle 10. The rear camera 26 and bed camera 28 may be understood as being rearward monitoring cameras.

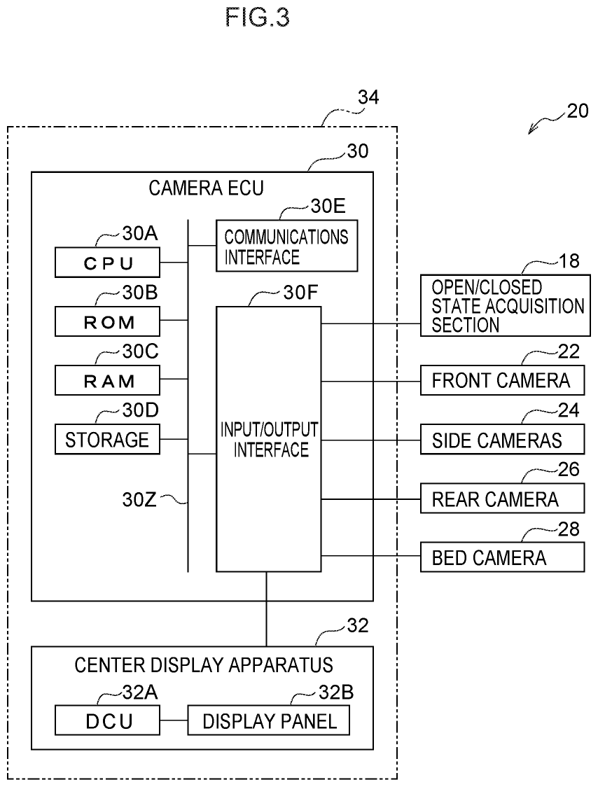

FIG. 3 shows a block diagram of an example of hardware structures of the vehicle monitoring device 20.

As shown in FIG. 3, the vehicle monitoring device 20 is provided with a camera electronic control unit (ECU) 30 to which the above-mentioned front camera 22, side cameras 24, rear camera 26 and bed camera 28 are connected. Although not described in detail here, the camera ECU 30 may compound the images captured by the separate cameras. An open/closed state acquisition section 18 and a center display apparatus 32 are also connected to the camera ECU 30.

The open/closed state acquisition section 18 is a unit that senses and acquires open or closed state of the tailgate 16 (an element that may be understood as an open or closed state detection sensor). The open/closed state acquisition section 18 includes, for example, a mechanical switch that is provided at the turning pivot 17 and outputs on and off signals in accordance with the open or closed state of the tailgate 16. Structures for sensing and acquiring open or closed state of opening/closing members such as tailgates and the like are publicly known, so are not described in detail here.

The center display apparatus 32 is provided with a display control unit (DCU) 32A and a display panel 32B that serves as a display section. The display panel 32B is provided at a vehicle width direction central portion of a front portion of the interior of the cabin 12 of the vehicle 10 and displays images (that is, shows video images). The DCU 32A includes functions for, in accordance with touch operations of the display panel 32B by a user, switching the display on the display panel 32B between one and another of captured images (video images) of the vehicle surroundings and information from a navigation system (not shown in the drawings). The navigation system is widely known, so is not described in detail here.

The camera ECU 30 includes a central processing unit (CPU) 30A that serves as a processor, read-only memory (ROM) 30B that serves as a memory and/or memory section, random access memory (RAM) 30C, storage 30D that serves as the memory and/or memory section, a communications interface 30E, and an input/output interface 30F. The CPU 30A, ROM 30B, RAM 30C, storage 30D, communications interface 30E and input/output interface 30F are connected with one another to be capable of communications via a bus 30Z. Although not shown in the drawings, the DCU 32A mentioned above is also provided with a CPU, ROM, RAM, storage, communications interface and input/output interface, which are connected with one another to be capable of communications via a bus. The meaning of the term “ROM” in the present Description is intended to include programmable ROM (PROM), erasable programmable ROM (EPROM), electrically erasable programmable ROM (EEPROM) and the like.

The CPU 30A is a central arithmetic processing unit that executes various programs and controls respective parts. That is, the CPU 30A reads a program from the ROM 30B or the storage 30D and executes the program, using the RAM 30C as a work area. The CPU 30A performs control of the structures described above and various kinds of computational processing and the like in accordance with programs recorded in the ROM 30B or the storage 30D.

The ROM 30B stores various programs and various kinds of data. For example, an image display control program for switching the image display in accordance with the open or closed state of the tailgate 16, an image recording control program for switching image recording in accordance with the open or closed state of the tailgate 16, and suchlike are stored in the ROM 30B. In addition, for example, images captured by the rear camera 26, the bed camera 28 and the like are recorded in the ROM 30B.

The RAM 30C serves as a work area and temporarily memorizes programs and data. The storage 30D includes a memory device such as a hard disk drive (HDD), a solid state drive (SSD) or the like. The storage 30D stores various programs and various kinds of data. The communications interface 30E is an interface for the camera ECU 30 to communicate with other equipment. For example, a wireless communications standard such as 4G, 5G, Wi-Fi (registered trademark) or the like can be used for these communications.

The input/output interface 30F is an interface for communicating with various equipment installed in the vehicle 10 (including ECUs (not shown in the drawings) other than the camera ECU 30). The camera ECU 30 according to the present exemplary embodiment is connected via the input/output interface 30F with, for example, the open/closed state acquisition section 18, the front camera 22, the side cameras 24, the rear camera 26, the bed camera 28 and the center display apparatus 32. Alternatively, the open/closed state acquisition section 18, front camera 22, side cameras 24, rear camera 26, bed camera 28 and center display apparatus 32 may be directly connected to the bus 30Z.

In the present exemplary embodiment, the camera ECU 30 and the center display apparatus 32 constitute a monitoring assistance section 34. When a state in which the tailgate 16 is in the closed state is acquired by the open/closed state acquisition section 18, the monitoring assistance section 34 uses images captured by the rear camera 26 to assist monitoring rearward of the vehicle 10, and when a state in which the tailgate 16 is in the open state is acquired by the open/closed state acquisition section 18, the monitoring assistance section 34 uses images captured by the bed camera 28 to assist monitoring rearward of the vehicle 10.

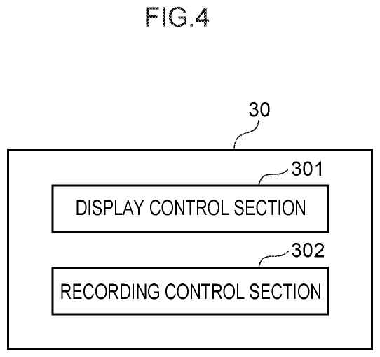

FIG. 4 is a block diagram showing an example of functional structures of the camera ECU 30. The camera ECU 30 includes the CPU 30A that serves as, as functional structures, a display control section 301 and a recording control section 302, as shown in FIG. 4.

The display control section 301 is manifested by the CPU 30A reading out and executing the image display control program memorized in the ROM 30B. The display control section 301 causes images captured by the rear camera 26 to be displayed at the display panel 32B of the center display apparatus 32 when the tailgate 16 being in the closed state is acquired by the open/closed state acquisition section 18, and causes images captured by the bed camera 28 to be displayed at the display panel 32B of the center display apparatus 32 when the tailgate 16 being in the open state is acquired by the open/closed state acquisition section 18.

The recording control section 302 is manifested by the CPU 30A reading out and executing the image recording control program memorized in the ROM 30B. The recording control section 302 causes images captured by the rear camera 26 to be recorded at the ROM 30B when a state in which the tailgate 16 is in the closed state is acquired by the open/closed state acquisition section 18, and causes images captured by the bed camera 28 to be recorded at the ROM 30B when a state in which the tailgate 16 is in the open state is acquired by the open/closed state acquisition section 18.

Now, operation of the vehicle monitoring device 20 is described.

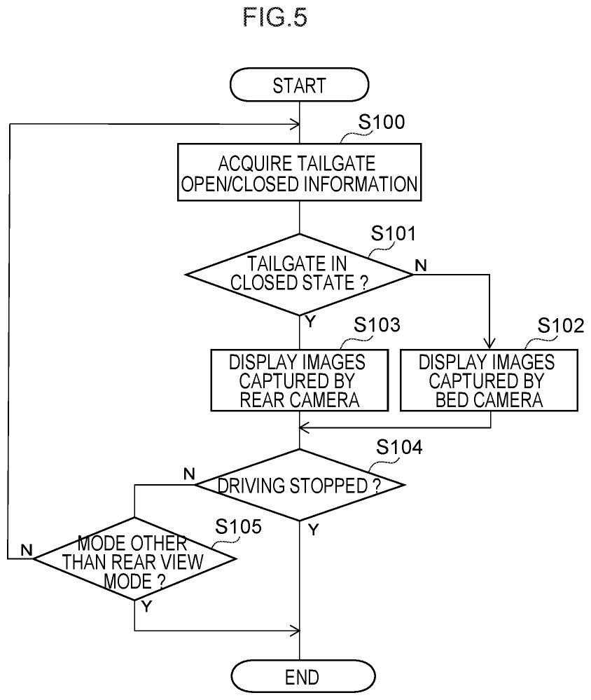

FIG. 5 is a flowchart showing an example of flow of the image display control processing by the camera ECU 30. The image display control processing is executed by the camera ECU 30, by the CPU 30A reading the image display control program from the ROM 30B, loading the program into the RAM 30C, and executing the program. Execution of the image display control processing shown in FIG. 5 starts, for example, when an ignition switch of the vehicle 10 is turned on and the display panel 32B is put into a mode of displaying images rearward of the vehicle (below referred to as a “rear view mode”) by touch operations of the display panel 32B by a user.

The CPU 30A acquires information on an open or closed state of the tailgate 16 from the open/closed state acquisition section 18 (step S100). Then, on the basis of the information acquired from the open/closed state acquisition section 18, the CPU 30A makes a determination as to whether the tailgate 16 is in the closed state (step S101).

When the CPU 30A determines that the tailgate 16 is not in the closed state, (“N” in step S101), the CPU 30A causes images captured by the bed camera 28 to be displayed at the display panel 32B of the center display apparatus 32 (step S102), and advances to the processing of step S104 (described below). When the CPU 30A determines that the tailgate 16 is in the closed state, (“Y” in step S101), the CPU 30A causes images captured by the rear camera 26 to be displayed at the display panel 32B of the center display apparatus 32 (step S103), and advances to the processing of step S104.

In step S104, on the basis of, for example, whether or not the ignition switch of the vehicle 10 has been turned off or the like, the CPU 30A makes a determination as to whether driving of the vehicle 10 has stopped. When the CPU 30A determines that driving of the vehicle 10 has stopped (“Y” in step S104), the CPU 30A ends the image display control processing shown in FIG. 5. When the CPU 30A determines that driving of the vehicle 10 has not stopped (“N” in step S104), the CPU 30A makes a determination as to whether the center display apparatus 32 is in a mode other than the rear view mode (step S105).

When the CPU 30A determines that the center display apparatus 32 is in the rear view mode (“N” in step S105), the CPU 30A repeats the processing from step S100. When the CPU 30A determines that the center display apparatus 32 is in a mode other than the rear view mode (“Y” in step S105), the CPU 30A ends the image display control processing shown in FIG. 5.

Thus, in the image display control processing shown in FIG. 5, one of images captured by the rear camera 26 and images captured by the bed camera 28 is selected to be display images as appropriate in accordance with the open or closed state of the tailgate 16. Therefore, in both the open and closed states of the tailgate 16, images rearward of the vehicle 10 may be displayed at the display panel 32B of the center display apparatus 32 in the cabin 12.

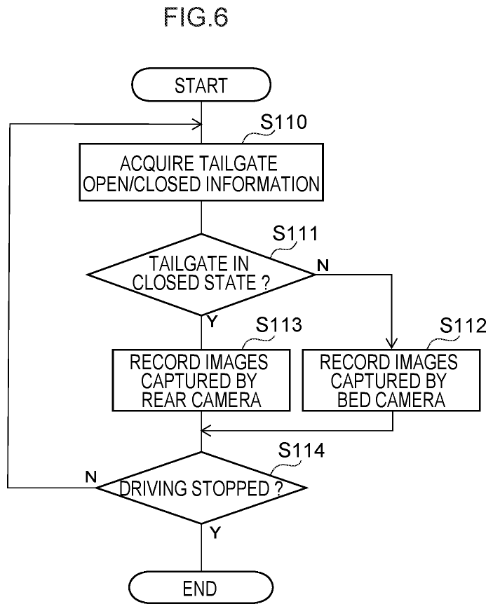

FIG. 6 is a flowchart showing an example of flow of the image recording control processing by the camera ECU 30. The image recording control processing is executed by the camera ECU 30, by the CPU 30A reading the image recording control program from the ROM 30B, loading the program into the RAM 30C, and executing the program. Execution of the image recording control processing shown in FIG. 6 starts, for example, when the ignition switch of the vehicle 10 is turned on.

The CPU 30A acquires information on an open or closed state of the tailgate 16 from the open/closed state acquisition section 18 (step S110). Then, on the basis of the information acquired from the open/closed state acquisition section 18, the CPU 30A makes a determination as to whether the tailgate 16 is in the closed state (step S111).

When the CPU 30A determines that the tailgate 16 is not in the closed state, (“N” in step S111), the CPU 30A causes images captured by the bed camera 28 to be recorded at the ROM 30B (step S112), and advances to the processing of step S114 (described below). When the CPU 30A determines that the tailgate 16 is in the closed state, (“Y” in step S111), the CPU 30A causes images captured by the rear camera 26 to be recorded at the ROM 30B (step S113), and advances to the processing of step S114.

In step S114, on the basis of, for example, whether or not the ignition switch of the vehicle 10 has been turned off or the like, the CPU 30A makes a determination as to whether driving of the vehicle 10 has stopped. When the CPU 30A determines that driving of the vehicle 10 has not stopped (“N” in step S114), the CPU 30A repeats the processing from step S110. When the CPU 30A determines that driving of the vehicle 10 has stopped (“Y” in step S114), the CPU 30A ends the image recording control processing shown in FIG. 6.

Thus, in the image recording control processing shown in FIG. 6, one of images captured by the rear camera 26 and images captured by the bed camera 28 is selected as images to be recorded as appropriate in accordance with the open or closed state of the tailgate 16. Therefore, in both the open and closed states of the tailgate 16, images rearward of the vehicle 10 may be recorded at the ROM 30B.

As described above, according to the vehicle monitoring device 20 according to the present exemplary embodiment, as shown in FIG. 2, images rearward of the vehicle 10 may be acquired and monitoring rearward of the vehicle 10 may be assisted excellently even when the vehicle 10 is running with the tailgate 16 in the open state.

As a variant example of the exemplary embodiment described above, a flow is possible in which step S104 and step S105 in FIG. 5 are omitted; the processing of either step S102 or step S103 continues until either of the conditions “when the CPU 30A determines that driving of the vehicle 10 has stopped” and “when the CPU 30A determines that the center display apparatus 32 is in a mode other than the rear view mode” is satisfied in that step.

As another variant example of the exemplary embodiment described above, a flow is possible in which step S114 in FIG. 6 is omitted; the processing of either step S112 or step S113 continues until the condition “when the CPU 30A determines that driving of the vehicle 10 has stopped” is satisfied in that step.

In the exemplary embodiment described above, the image display control program and the image recording control program are stored in the ROM 30B shown in FIG. 3 but, as a variant example of the exemplary embodiment described above, one or both of the image display control program and the image recording control program may be stored in the storage 30D rather than the ROM 30B.

In the exemplary embodiment described above, images to the rear side of the vehicle 10 are recorded in the ROM 30B but, as another variant example of the exemplary embodiment described above, a configuration is possible in which images to the rear side of the vehicle 10 are recorded in the storage 30D rather than the ROM 30B.

As a further variant example of the exemplary embodiment described above, a structure is possible in which a camera ECU (30) is not directly connected to an open/closed state acquisition section (18); information relating to open or closed state of a tailgate (16) is received by controller area network (CAN) communications from another ECU (not shown in the drawings), which is connected to the open/closed state acquisition section (18).

In the exemplary embodiment described above, the camera ECU 30 includes both the display control section 301 and recording control section 302 shown in FIG. 4 as functional structures but, as still another variant example of the exemplary embodiment described above, a configuration may be employed in which a camera ECU (30) includes only one of a display control section (301) and a recording control section (302) as a functional structure.

The processing executed by the CPU 30A of the exemplary embodiment described above, which is shown in FIG. 3, reading and executing software (programs) may be executed by various kinds of processor other than a CPU. Examples of processors in these cases include a PLD (programmable logic device) in which a circuit configuration can be modified after manufacturing, such as an FPGA (field programmable gate array) or the like, a dedicated electronic circuit which is a processor with a circuit configuration that is specially designed to execute specific processing, such as an ASIC (application-specific integrated circuit) or the like, and so forth. The processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

The programs described in the above exemplary embodiment may be provided in a mode of being memorized on a non-transitory recording medium, such as a CD-ROM (compact disc read-only memory), DVD-ROM (digital versatile disc read-only memory), USB (universal serial bus) memory or the like. Modes are also possible in which the program is downloaded from external equipment via a network.

The exemplary embodiment described above and variant examples mentioned above may be embodied in suitable combinations.

Hereabove, examples of the present disclosure have been described. The present disclosure is not limited by these descriptions and it will be clear that numerous modifications beyond these descriptions may be embodied within a technical scope not departing from the gist of the disclosure.

What is claimed is:

1. A vehicle monitoring device for installment in a vehicle in which a cargo bed is provided at a rear side of a cabin and a tailgate is provided at a rear end portion of the cargo bed, the vehicle monitoring device comprising:
a memory; and
a processor connected to the memory, the processor being configured to:
cause a first imaging unit installed at a rear face portion of the tailgate to capture an image rearward of the vehicle;
cause a second imaging unit installed at a cabin rear end portion side of an upper portion of the vehicle to capture an image of the cargo bed and rearward of the vehicle;
cause an open or closed state acquisition section to acquire an open or closed state of the tailgate; and
when a state in which the tailgate is in a closed state is acquired by the open or closed state acquisition section, use images captured by the first imaging unit to assist monitoring rearward of the vehicle, and when a state in which the tailgate is in an open state is acquired by the open or closed state acquisition section, use images captured by the second imaging unit to assist monitoring rearward of the vehicle.

2. The vehicle monitoring device according to claim 1, further comprising a display section that is provided in the cabin of the vehicle and displays images, wherein the processor is configured to:
when a state in which the tailgate is in the closed state is acquired by the open or closed state acquisition section, display images captured by the first imaging unit at the display section, and
when a state in which the tailgate is in the open state is acquired by the open or closed state acquisition section, display images captured by the second imaging unit at the display section.

3. The vehicle monitoring device according to claim 1, further comprising a recording section that records images, wherein the processor is configured to:
when a state in which the tailgate is in the closed state is acquired by the open or closed state acquisition section, record images captured by the first imaging unit at the recording section, and
when a state in which the tailgate is in the open state is acquired by the open or closed state acquisition section, record images captured by the second imaging unit at the recording section.

4. A vehicle monitoring method performed by a processor, for a vehicle monitoring device installed in a vehicle in which a cargo bed is provided at a rear side of a cabin and a tailgate is provided at a rear end portion of the cargo bed, the vehicle monitoring device including a memory and the processor, which is connected to the memory, and the vehicle monitoring method comprising:
causing a first imaging unit installed at a rear face portion of the tailgate to capture an image rearward of the vehicle;
causing a second imaging unit installed at a cabin rear end portion side of an upper portion of the vehicle to capture an image of the cargo bed and rearward of the vehicle;
causing an open or closed state acquisition section to acquire an open or closed state of the tailgate; and
when a state in which the tailgate is in a closed state is acquired by the open or closed state acquisition section, using images captured by the first imaging unit to assist monitoring rearward of the vehicle, and when a state in which the tailgate is in an open state is acquired by the open or closed state acquisition section, using images captured by the second imaging unit to assist monitoring rearward of the vehicle.

5. The vehicle monitoring method according to claim 4, wherein the vehicle monitoring device includes a display section that is provided in the cabin of the vehicle and displays images, and the processor:
when a state in which the tailgate is in the closed state is acquired by the open or closed state acquisition section, displays images captured by the first imaging unit at the display section, and
when a state in which the tailgate is in the open state is acquired by the open or closed state acquisition section, displays images captured by the second imaging unit at the display section.

6. The vehicle monitoring method according to claim 4, wherein the vehicle monitoring device includes a recording section that records images, and the processor:
when a state in which the tailgate is in the closed state is acquired by the open or closed state acquisition section, records images captured by the first imaging unit at the recording section, and
when a state in which the tailgate is in the open state is acquired by the open or closed state acquisition section, records images captured by the second imaging unit at the recording section.

7. A non-transitory memory medium storing a program executable by a processor to perform vehicle monitoring processing at a vehicle monitoring device installed in a vehicle in which a cargo bed is provided at a rear side of a cabin and a tailgate is provided at a rear end portion of the cargo bed, the vehicle monitoring device including a memory and the processor, which is connected to the memory, and the vehicle monitoring processing comprising:
causing a first imaging unit installed at a rear face portion of the tailgate to capture an image rearward of the vehicle;
causing a second imaging unit installed at a cabin rear end portion side of an upper portion of the vehicle to capture an image of the cargo bed and rearward of the vehicle;
causing an open or closed state acquisition section to acquire an open or closed state of the tailgate; and
when a state in which the tailgate is in a closed state is acquired by the open or closed state acquisition section, using images captured by the first imaging unit to assist monitoring rearward of the vehicle, and when a state in which the tailgate is in an open state is acquired by the open or closed state acquisition section, using images captured by the second imaging unit to assist monitoring rearward of the vehicle.

8. The non-transitory memory medium according to claim 7, wherein the vehicle monitoring device includes a display section that is provided in the cabin of the vehicle and displays images, and the vehicle monitoring processing includes:
when a state in which the tailgate is in the closed state is acquired by the open or closed state acquisition section, displaying images captured by the first imaging unit at the display section, and
when a state in which the tailgate is in the open state is acquired by the open or closed state acquisition section, displaying images captured by the second imaging unit at the display section.

9. The non-transitory memory medium according to claim 7, wherein the vehicle monitoring device includes a recording section that records images, and the vehicle monitoring processing includes:
when a state in which the tailgate is in the closed state is acquired by the open or closed state acquisition section, recording images captured by the first imaging unit at the recording section, and
when a state in which the tailgate is in the open state is acquired by the open or closed state acquisition section, recording images captured by the second imaging unit at the recording section.
